(19) United States
(12) Patent Application Publication
(10) Pub. No.: US 2026/0229861 A1
(43) Pub. Date: Aug. 6, 2026

(54) OPTIMIZED HYGIENIC CABLE HOLDER SYSTEM

(71) Applicant: VECOTEC BV, STADEN (BE)

(72) Inventor: Bob VERPLANCKE, STADEN (BE)

(21) Appl. No.: 19/152,612

(22) PCT Filed: Feb. 27, 2024
(86) PCT No.: PCT/IB2024/051843

§ 371 Date: Jul. 31, 2025

(30) Foreign Application Priority Data
Feb. 28, 2023 (BE) BE2023/5145

(51) Int. Cl. H02G 3/04; F16L 3/22; H02G 3/30

(52) U.S. Cl. CPC H02G 3/0456; F16L 3/222; H02G 3/30

(57) ABSTRACT

Disclosed herein is a cable holder system for hygienically securing cables and/or lines, including a set of at least two cable holders positioned at a distance from each other, where each cable holder extends in a main direction and is formed from a one-piece rigid wire profile. The profile includes a number of successive recurring zones in which the wire profile is folded a number of times such that a receiving space for a cable and/or line is formed at the location of each zone. Further, during use, a cable and/or line extending transverse to the main direction can be placed bearing against the support part of a specific zone of the cable holders via a flexible bending of the cable or line along a screening part, which prevents unintentional loss of the cable and/or line from the receiving space.

This application is a National Phase entry of International Application No. PCT/IB2024/051843 under § 371 and claim the benefit of Belgium Patent Application No. BE2023/5145 filed on Feb. 28, 2023, which is hereby incorporated by reference in its entirety.

### FIELD OF THE DISCLOSURE

The present disclosure relates to a cable holder system for hygienically securing cables and/or lines, comprising a set of at least two cable holders positioned at a distance from each other, wherein each cable holder extends in a main direction and is formed from a one-piece rigid wire profile which comprises a number of successive recurring zones in which the wire profile is folded a number of times such that a receiving space for a cable and/or line is formed at the location of each zone, wherein a support part for a cable and/or line and a screening part are formed in each zone by the folding or bending of the wire profile, wherein the cable holder system is configured such that, during use, a cable and/or line extending transverse to the main direction can be placed bearing against the support part of a specific zone of said cable holders by means of flexible bending of the cable or line along a screening part and the screening part prevents unintentional loss of the cable and/or line from the cable holder, wherein the screening parts of successive zones of the same cable holder are positioned such that they are offset with respect to each other in an offsetting direction transverse to the main direction.

The present disclosure relates in particular to a cable holder system for supporting and securing a respective cable or line of a series of cables and/or lines (e.g. for compressed air or water) which extend one above the other on walls or machines without the use of additional securers such as cable ties and brackets.

### BACKGROUND

In the food industry, cables (or lines) have to be secured as hygienically as possible. This means that it is necessary to ensure that cables and/or lines which are fitted in a cable holder system or are fitted against a supporting surface by means of a securing system are easy to clean.

Perishable product residues (small pieces of meat, vegetables, dairy products, etc.) which come into contact with the securing system for one reason or another must not become trapped in the system. After a short period of time, these product residues will (defrost and) perish, resulting in a significant increase in the growth of bacteria. These undesired bacteria may then end up back in the food, which jeopardizes the food safety. If this is indeed the case, it is therefore necessary for the system to be able to be cleaned to the greatest extent possible, such that the perishable residues can be removed.

The known securing of the cables (lines) by means of specific profiles, such as pipes, tubes, etc., poses a risk because bacteria may grow in these securing profiles, and if cleaning is then performed, the inside of the profiles in question cannot be properly accessed, resulting in the growth of bacteria.

So as to be able to do this in a hygienic manner, it is also possible to use closed pipes with cable glands on the ends, but this has the drawback that drawstrings are required in order to be able to accommodate several cables in the pipe, otherwise the cables become tangled. It is additionally also time-consuming to do this.

For hygienic reasons, an open system will thus often be used. Such open systems use a system of cable nets or wire trays, the cables and/or lines being secured to the cable nets or wire trays by means of additional securers such as cable ties.

Cable nets or wire trays consist of longitudinal and transverse wires that are welded to each other. They have the drawback that product residues such as vegetables can still easily remain behind, become hooked or stuck at the welded connection. These perishable products can then begin to rot and the bacteria can grow as a result.

The use of additional securers such as cable ties on a conventional wire tray also has its drawbacks. At the point where the cables are secured together with a cable tie, dirt can accumulate between the cables and the cable tie, with the result that growth of bacteria occurs. In addition, the fitting of cable ties is also time-consuming.

The existing wire nets are also always constructed in such a way that one or more uninterrupted round wires are situated along the rear of the nets. Between these wires and the surface where these are secured, it is also still possible for residual products to accumulate, resulting in the growth of bacteria.

If pressurized water is used to clean after a production run in the food industry, the bacteria are sprayed around. This bears the risk of the bacteria being spread throughout the factory and contaminating the open product or the machines. In the latest recommendations on cleaning of lines in the food industry, the use of water is discouraged and instead the advice is given to use wipes sprinkled with an alcoholic agent (disinfection) to clean the machines, cable guides, etc. regularly. To this end, it has to be possible to untie the cables easily, since, once they have been untied, it is possible to use the wipe on all sides of the cables and to clean them thoroughly. Then, it has to be possible to secure them in the system again, such that they no longer hang loosely and are not able to rotate along with rotating components of the machines.

European patent publication EP 3 944 437 A1 in the name of the current applicant describes a solution for hygienically securing cables and/or lines which allows a cable and/or line to be secured in a simple and smooth manner and is additionally easy to clean. That publication describes a cable holder system consisting of a number of cable holders arranged in parallel and two supporting profiles running in parallel, wherein the cable holders are placed next to each other at a distance from each other in a direction perpendicular to the longitudinal direction of the supporting profiles. The cable holders are manufactured from a one-piece rigid wire profile which comprises a number of constantly recurring and successive zones in which the wire profile is folded a number of times, such that a receiving space for a cable and/or line is formed at the location of each zone, said receiving space extending in the longitudinal direction of the supporting profiles. In practice, a respective separate bundle of a number of cables and/or lines are provided in each receiving space, as a result of which the user can use the described cable holder system to secure a number of series of cable bundles which extend one above the other.

Due to the increasingly stringent hygiene requirements, there is a market demand for a cable holder system in which the cables or lines extend one by one above each other, instead of bundles which extend one above the other. Dirt which is very difficult to remove can specifically still accumulate between a bundle of cables (or lines) and growth of bacteria can occur as a result. In the cable holder system as described in EP 3 944 437 A1, separate securing, the so-called ‘single wire’ principle, of individual cables or lines is possible in principle but not feasible in practice because the cable holder system would take up too much space in terms of height.

American patent publication US 2022/112969 A1 describes a complex cable support system comprising a number of V-bracket assemblies which are at a distance from each other and are aligned so as to form first and second sides which define an angle therebetween. A first cable support apparatus is placed on the first side and secured to the number of V-bracket assemblies, and a second cable support apparatus is placed on the second side and secured to the number of V-bracket assemblies in such a way that the first and second cable-supporting apparatuses define the angle therebetween. Each of the first and second cable support apparatuses comprises a number of horizontal supports composed of wire material and a number of first vertical supports composed of wire material. Each first vertical support comprises a vertical segment which is connected to the horizontal supports at intersections therebetween, and an upper cable receiving element which extends outwards from the corresponding vertical segment. The upper cable receiving elements of the first vertical supports cooperate so as to define a first upper cable receiving channel which extends along them. In the case of the cable support system described in US 2022/112969 A1, the cables have to be fitted via the top side in the access opening of the cable receiving channel, as a result of which a sufficient distance, at least greater than the diameter of the cables to be fitted, must be provided between the different cable receiving channels. In this way, it is not possible to produce a compact system; in addition, at least two different forms of cable receiving elements are required if more than two cable receiving channels are desired to be provided. The system described in US 2022/112969 A1 is also complex in terms of structure and additionally difficult to clean.

### SUMMARY

The cable holder system according to the present disclosure was developed for use in the food industry.

An aim of at least one embodiment of the present invention is therefore to develop a compact cable holder system which can be produced in a simple manner and in which the cables or lines preferably extend in accordance with the ‘single wire principle’, i.e. a system in which cables or lines extend one by one above each other. An additional aim is that it must still be possible to secure or remove each individual cable or line simply and smoothly in or from the cable holder system.

The aforementioned aim of the at least one embodiment of the invention is achieved by providing a cable holder system for hygienically securing cables and/or lines, comprising a set of at least two cable holders positioned at a distance from each other, wherein each cable holder extends in a main direction and is formed from a one-piece rigid wire profile which comprises a number of successive recurring zones in which the wire profile is folded a number of times such that a receiving space for a cable and/or line is formed at the location of each zone, wherein a support part for a cable and/or line and a screening part are formed in each zone by the folding or bending of the wire profile, wherein the cable holder system is configured such that, during use, a cable and/or line extending transverse to the main direction can be placed bearing against the support part of a specific zone of said cable holders by means of flexible bending of the cable or line along a screening part and the screening part prevents unintentional loss of the cable and/or line from the receiving space, wherein the screening parts of the successive zones of the same cable holder are positioned such that they are offset with respect to each other in an offsetting direction transverse to the main direction, wherein the spacing between the perpendicular projection of the top side of a screening part of the one zone of the cable holder in a projection plane parallel to the main direction and parallel to the offsetting direction and the perpendicular projection of the bottom side of the support part of the following zone of the same cable holder in said projection plane is at most equal to the diameter of a cable and/or line fitted in the receiving space. This will ensure that there is additional security against unintentional loss of a cable or line placed in the corresponding receiving space. Preferably, said offsetting direction is the same as the direction in which the cables and/or lines extend in use.

The cable holder system is preferably suitable for receiving cables and/or lines having a diameter within the range from 1 mm to 40 mm, preferably within the range from 1 mm to 20 mm, more particularly within the range from 1 mm to 10 mm. In a cable holder system according to a preferred embodiment the invention, said spacing is therefore at most equal to 40 mm, preferably at most equal to 20 mm, preferably at most equal to 10 mm.

In a preferred embodiment of the cable holder system, the top side of the screening part of a specific receiving space extends to at least a height at which the bottom side of the support surface of the following receiving space extends. In the case that the top side of the screening part of a specific receiving space extends to a height at which the bottom side of the support surface of the following receiving space extends, the spacing between the perpendicular projection of the top side of a screening part of the one zone of the cable holder in said projection plane and the perpendicular projection of the bottom side of the support part of the following zone of the same cable holder in this projection plane is equal to 0 mm. The perpendicular projections in question notably coincide with each other.

In another preferred embodiment, the perpendicular projection of the top side of a screening part of the one zone of the cable holder in the projection plane is located-as seen in the main direction-at least below the height at which the perpendicular projection of the bottom side of the support part of the following zone of the same cable holder in said projection plane is located.

In a preferred embodiment, the distance between the receiving spaces of successive zones is equal to the thickness of the wire profile. Due to the fact that the screening parts are arranged offset with respect one another, the distance between successive zones is limited to the thickness of the wire profile of the cable holder. In particular, a screening part which forms part of a specific zone is offset with respect to the screening part of the preceding zone. This makes it possible to use the length of the cable holder in an optimal manner, and more zones, and thus also more receiving spaces, can be formed. Preferably, each receiving space is suitable for receiving at most one individual line or cable. This is of particular importance if the cable holder system is used in environments where hygiene is important. It goes without saying that, in the case that the cable holder system is used in environments where hygiene is of lesser importance, multiple cables and/or lines may be placed in each receiving space of the cable holder.

A receiving space can be defined as the enclosed space which is visible when the cable holder is viewed transverse to the main direction. This is also the direction in which the stretched locked cable or line extends.

The different zones of the same cable holder preferably extend at a different height. In particular, as seen in the main direction of the cable holder, a screening part which forms part of a specific zone is offset with respect to the screening part of the preceding zone. More particularly, as seen in the main direction, the screening parts of the successive zones of a cable holder are in a staggered arrangement. In the case of a staggered arrangement, the screening part of the successive zones, as seen in the main direction of the cable holder, will first be located on the right side of the cable holder, on the left side in the following zone, back on the right side in the following zone, etc. It goes without saying that in the case that one starts with a zone in which the screening part is located on the left side, the screening part of the following zone will be located on the right side, etc.

The different cable holders will be secured against or to a supporting surface for use. The positioning of the different cable holders with respect to each other, once secured against or to the supporting surface, is determined by the direction in which the cables and/or lines to be placed in the cable holders extend. In practice, the different cable holders of the same set are located at a distance of between 80 mm and 500 mm from each other. Preferably, the different cable holders of the same set are placed at 250 mm from each other.

In a first preferred embodiment, the cable holders positioned at a distance from each other will extend parallel to each other in the main direction. In a second preferred embodiment, the cable holders positioned at a distance from each other will not extend parallel to each other in a main direction. This is for example of use when the cables and/or lines extend along an upwardly or downwardly extending curve.

In the case of a staggered arrangement of the screening parts, in a preferred embodiment the top end of a screening part will extend beyond the bottom side of the next screening part of the next zone. In this case, the perpendicular projection of the top end of a screening part of the one zone of the cable holder in the projection plane is located-as seen in the main direction beyond the height at which the perpendicular projection of the bottom side of the next screening part of the next zone in said projection plane is located. This creates an overlap which will ensure that there is additional security against unintentional loss of a cable or line placed in the corresponding receiving space. Each screening part preferably has a height which at least corresponds to the thickness of the cable and/or line placed in the corresponding receiving space.

According to a cable holder system according to a first embodiment the invention, the different cable holders of a set are each separately secured against a securing surface, such as a machine or a construction. Here, the securing will preferably be effected by means of a welded connection. In a cable holder system according to a second preferred embodiment of the invention, said system comprises one or more supporting profiles which extend in parallel and against which said cable holders of a set are able to be secured. The supporting profiles are preferably a pipe, rod or folded element composed of, for example, sheet material. The supporting profiles extend in a direction transverse to said main direction.

The wire profile is in a folded form, wherein a repeating pattern (zones) is produced having, on one side, an opening in which the cables and/or lines can be placed (woven). When looking in the longitudinal direction of the secured cables, it can be seen that these are surrounded by the profile. Due to the rigidity of the secured cables, these are automatically locked between the profiles.

Since the wire profile is an uninterrupted round wire in a preferred embodiment, this is an open structure and thus easy to clean. Since this is an uninterrupted, preferably round wire, there are no cross-connections of wires, so no residual material can become trapped here. Since, in practice, there is also only one wire or line placed in those zones of the different cable holders which extend at the same height, this wire or line will therefore be easy to clean.

Due to the repeating pattern (zones) which creates an opening on one side, it is possible to weave the cables, and due to the rigidity of the cables, these are automatically locked. As a result, no additional connectors or securers are necessary and the cables are loosely locked in a specific zone of the cable holder.

By applying a slight force in the transverse direction of a locked cable, it is also possible to remove it from said receiving space through the opening. As a result, these can be cleaned regularly using a disinfecting wipe.

Since no additional securers (e.g., cable ties) are required, this system also saves time when fitting cables, and this affords an economic advantage.

In at least one embodiment of the present invention, a round wire profile composed of metal will be used as the base material for forming the different cable holders. This wire profile preferably has a thickness of between 2 mm and 10 mm, more particularly the thickness of the wire profile is between 2 mm and 6 mm, even more particularly the wire profile has a thickness of 4 mm.

The wire profile will be formed in the repeating pattern. The distance between the successive zones is determined by the wire profile thickness. The height of the receiving space is selected as a function of the thickness of the cables and/or lines. Preferably, the height of the receiving space is between 5 mm and 80 mm. The width of the receiving space varies depending on the thickness of the cable or line which has to be secured in a specific zone. The opening via which the cables can be woven into the receiving space and which is situated between two successive screening parts of the same cable holder has a width which is preferably between 15 mm and 120 mm.

Various embodiments of the invention are possible. These may differ in accordance with the form of the repeating pattern. It is typical of the repeating pattern that access openings for the receiving space are produced on one side in each case. Via this opening, the cables can be introduced (woven) into the different zones of the cable holders positioned next to each other —at a spacing. Depending on the pattern, this opening may in each case be situated on the same side or may be on alternate sides.

Various embodiments of the invention are possible. The form of the enclosure of the cables to be secured may vary. In the figures, viewing in the longitudinal direction of the cables to be secured, there is always a square shape. This may also be a rectangular or round shape or any other shape which encloses the cables.

Various embodiments of the invention are possible. The cross section of the wire profile may also vary; it will be made from a round wire. Any other shape of cross section may be used, such as square, rectangular cross sections, oval cross section, etc.

Various embodiments of the invention are possible. Regarding the material of the wire profile, there are various possibilities, such as stainless steel, galvanized steel, galvanized metal, aluminium, plastic, etc.

Although the disclosure describes embodiments intended for use in the food industry, a skilled artisan will recognize that such embodiments, as well as other embodiments, may also be used in various other environments where cables or lines have to be secured.

Preferred embodiments of the cable holder are described still further in the dependent claims.

In order to further illustrate the properties of embodiments of the present invention and to indicate additional advantages and particular features thereof, a more detailed description of the cable holder system according to such embodiments will now be given. It will be clear that nothing in the following description may be interpreted as a limitation of the protection of the disclosure as laid down in the claims.

### BRIEF DESCRIPTION OF THE DRAWINGS

In the present description, reference numerals and letters are used to refer to the attached drawings, in which:

FIG. 1 is an illustration of a first possible embodiment of the cable holder system according to the invention, comprising a set of five cable holders which are positioned at a distance from each other, extend parallel to each other in a main direction and are provided between two supporting profiles, wherein it is illustrated how a cable is secured and how the cables extend rectilinearly at a different height, at a spacing from each other, after being secured;

FIG. 2 is a side view of the embodiment presented in FIG. 1;

FIG. 3 is an illustration of the cable holder system depicted in FIG. 1, but without cables or lines;

FIG. 4 is a detail view of the cable holder used in FIGS. 1 and 2;

FIG. 5 is a side view of the cable holder presented in FIG. 4;

FIG. 6 is an illustration of a second possible embodiment of the cable holder system according to the invention, comprising a set of five cable holders which are positioned at a distance from each other, extend parallel to each other in a main direction and are provided between two supporting profiles, wherein it is illustrated how a cable is secured and how the cables extend rectilinearly at a different height, at a spacing from each other, after being secured;

FIG. 7 is an illustration of the cable holder system depicted in FIG. 6, but without cables or lines;

FIG. 8 is a detail view of the cable holder used in FIGS. 6 and 7;

FIG. 9 is an illustration of one possible embodiment in which the cable holders are secured against one supporting profile;

FIG. 10 is an illustration of one possible embodiment in which the cable holders are secured against multiple (in the present case three) supporting profiles;

FIG. 11 is a perspective view of a cable holder of a cable holder system according to at least one embodiment of the invention, indicating the perpendicular projections of the top side of a screening part of one zone of the cable holder in a projection plane—defined by the main direction in which the cable holder extends and the offsetting direction of the screening parts of the cable holder in question—in which the different support parts of the same cable holder extend, and the perpendicular projection of the bottom side of the support part of the following zone of the same cable holder in said projection plane, wherein the perpendicular projection of the top side of a screening part of the one zone of the cable holder in the projection plane is located-as seen in the main direction-at least beyond the height at which the perpendicular projection of the bottom side of the support part of the following zone of the same cable holder in said projection plane is located, such that a mutual overlap is produced;

FIG. 12 shows a front view of the cable holder shown in FIG. 11;

FIG. 13 is a perspective view of a cable holder of a cable holder system according to at least one embodiment of the invention, wherein the spacing between the perpendicular projection of the top side of a screening part of the one zone of the cable holder in said projection plane and the perpendicular projection of the bottom side of the support part of the following zone of the same cable holder in this projection plane is equal to 0 mm;

FIG. 14 shows a front view of the cable holder shown in FIG. 13;

FIG. 15 is a perspective view of a cable holder of a cable holder system according to at least one embodiment of the invention, wherein the perpendicular projection of the top side of a screening part of the one zone of the cable holder in said projection plane is located below the perpendicular projection of the bottom side of the support part of the following zone of the same cable holder in this projection plane;

FIG. 16 shows a front view of the cable holder shown in FIG. 15.

### DETAILED DESCRIPTION

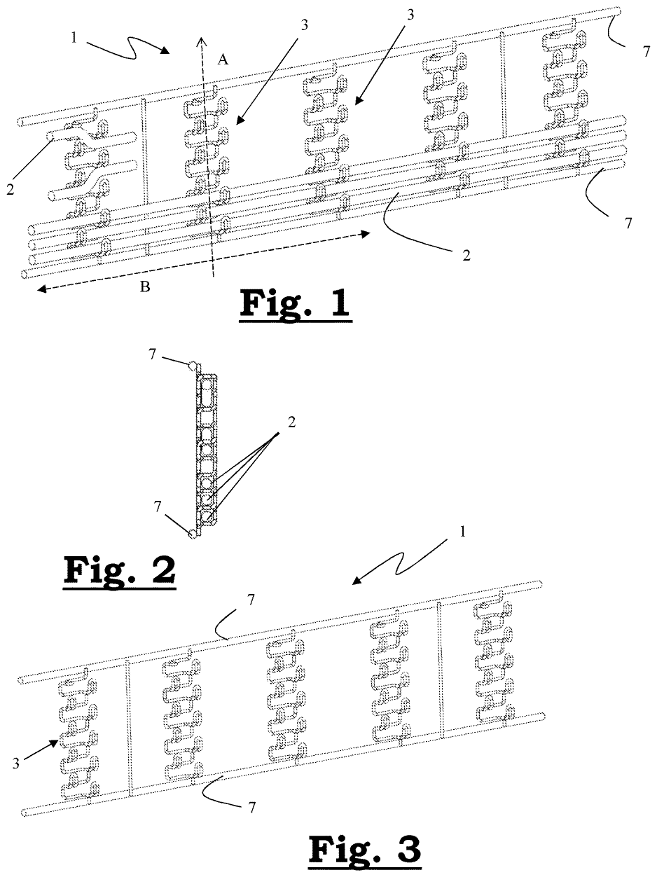

The cable holder system (1) according to the disclosure, and of which a number of possible embodiments are presented in FIGS. 1, 3, 6 and 7, was specifically developed to secure any cable (2) or line, separately, at a spacing from each other, in a simple manner, and in a hygienic manner. The cable holder system described herein is designed such that it is a compact system which is able to be easily secured to or against a supporting surface.

The cable holder system (1) comprises a number of cable holders (3) positioned at a distance from each other. In practice, the cable holders (3) are placed at approximately 250 mm from each other, and, in principle, against a supporting surface. The cable holders (3) are formed from a one-piece rigid wire profile (4) composed of a suitable material; this is often stainless steel. For non-food-specific applications, it is possible for galvanized metal to be used instead of stainless steel.

In practice, the wire profile has a diameter of approximately 4 mm. Such a thickness will ensure a suitable rigidity of the cable holder. The wire profile (4) is bent a number of times so as to thus form a cable holder (1) which comprises a number of successive recurring (repeating) zones. The bends or folds in the wire profile may be provided mechanically by means of a machine configured for this purpose. In an alternative embodiment, a cable holder having such bends or folds, for forming the zones in question, may also be formed by means of 3D printing technology or by means of a casting process.

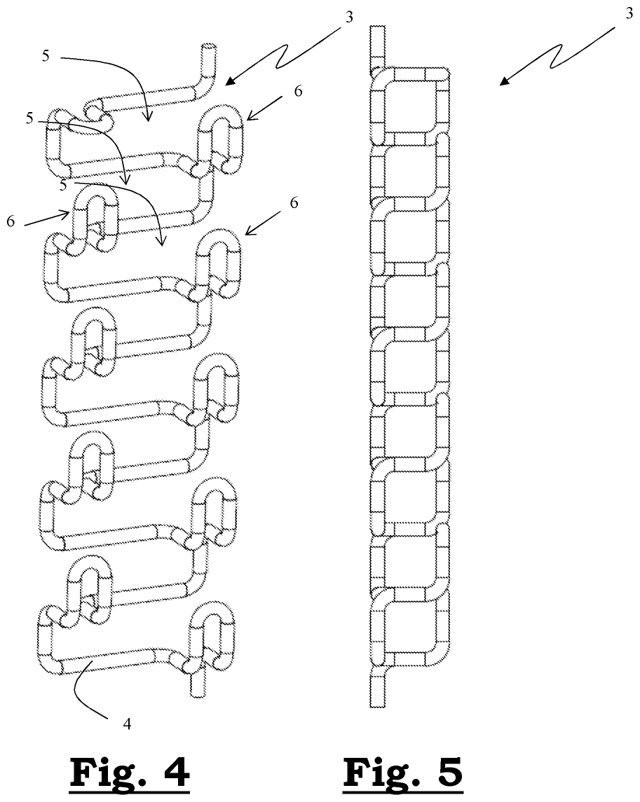

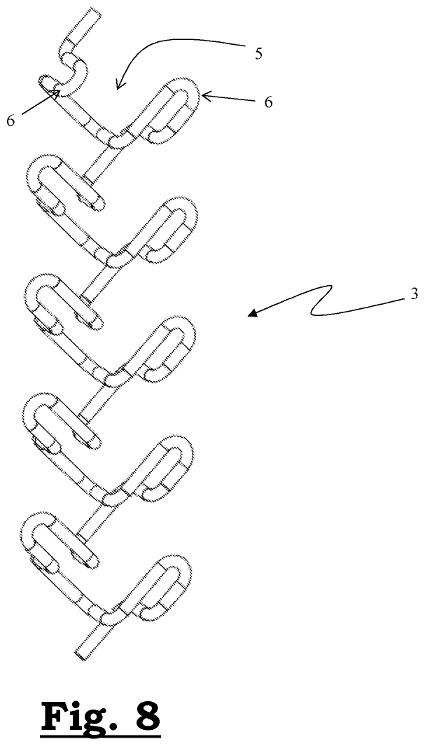

The wire profile (4) is folded (or bent) in such a way that a receiving space (5) for a cable (2) and/or line is formed at the location of each said zone, wherein a support part for a cable and/or line and a screening part (6) are formed in each zone by the folding or bending of the wire profile (4). This is clearly visible, inter alia, in FIGS. 4 and 8, which each show a possible embodiment of a cable holder. In FIG. 4, the different screening parts are arranged directly upright, whereas the screening parts depicted in FIG. 8 are arranged obliquely upright.

Each cable holder (3) extends in a specific main direction, indicated by reference letter (A) in, inter alia, FIG. 1. This main direction extends in the longitudinal direction of the cable holder.

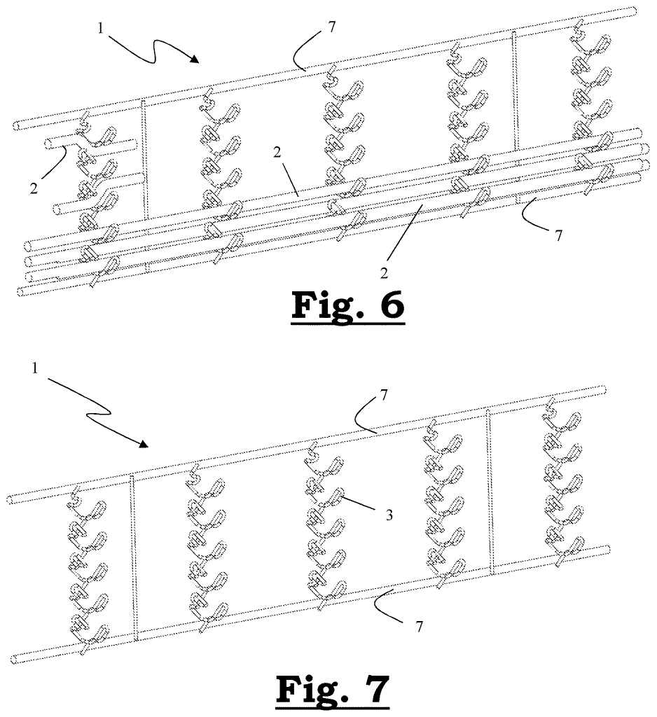

The cable holder system (1) is configured such that, during use, a cable (2) and/or line extending transverse to the main direction (A) can be placed bearing against the support part of a specific zone of said cable holders (3) in a receiving space by means of flexible bending of the cable (2) or line along a screening part (6). The introduction of a cable into a receiving space, notably the bending thereof, is illustrated via the two upper cables, visible in FIGS. 1 and 6.

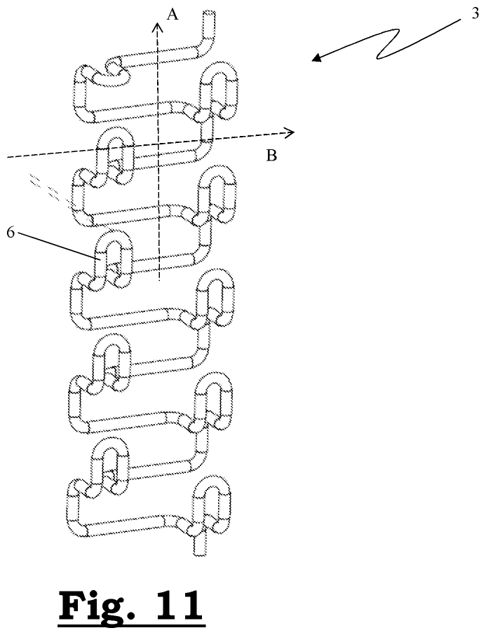

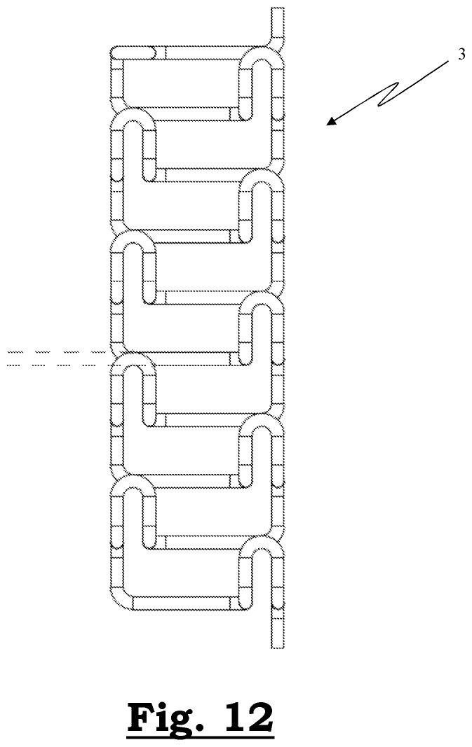

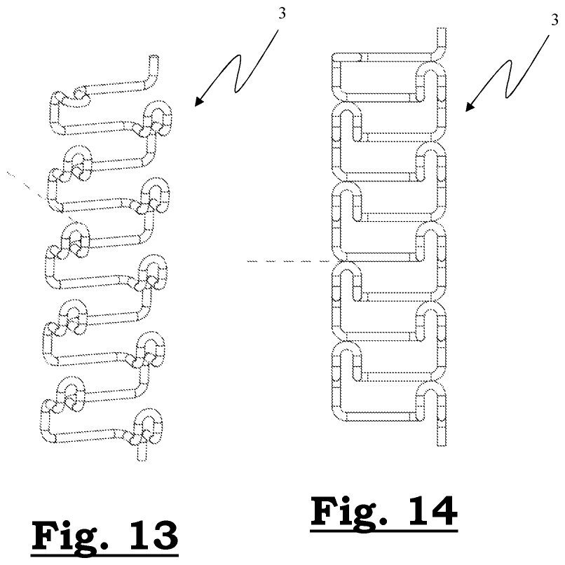

In each zone, the screening part (6) will prevent unintentional loss of the cable (2) and/or line from the receiving space (5). What is special about at least one embodiment of the cable holder system is that the screening parts (6) of the successive zones of the same cable holder (3) are positioned such that they are offset with respect to each other in an offsetting direction, indicated by reference letter (B), which extends in a direction transverse to the main direction (A). The offsetting direction in question is preferably the same as the direction in which a cable (2) and/or line extends when the cable holder system (1) is being used. Due to the fact that the screening parts are arranged offset with respect one another, the distance between successive zones is limited to the thickness of the wire profile of the cable holder. This makes it possible to produce a compact cable holder system. Here, it is important to note that, in order to prevent unintentional loss of the cable (2) and/or line from the receiving space (5), and as illustrated in FIGS. 11 to 16, the spacing between the perpendicular projection of the top side of a screening part (6) of the one zone of the cable holder (3) in a projection plane which extends parallel to the main direction (A) and also parallel to the offsetting direction (B) and the perpendicular projection of the bottom side of the support part of the following zone of the same cable holder (3) in said projection plane is at most equal to the diameter of a cable (2) and/or line fitted in the receiving space (5).

The cable holder system is preferably suitable for receiving cables and/or lines having a diameter within the range from 1 mm to 20 mm, preferably within the range from 1 mm to 10 mm. In a cable holder system according to a preferred embodiment of the invention, said spacing is therefore at most equal to 20 mm, preferably at most equal to 10 mm.

Depending on the positioning of the screening parts of a cable holder, the top end of a screening part (6) in a specific zone of the successive zones of the cable holder (3) may extend beyond, or to the same height as, or below the bottom side of the next screening part (6) of the following zone. This is illustrated in FIGS. 11 to 16, FIG. 11 showing a cable holder of which the perpendicular projection of the top side of a screening part of the one zone of the cable holder in the projection plane is situated—as seen in the main direction—above the perpendicular projection of the bottom side of the support part of the following zone of the same cable holder in said projection plane, such that a mutual overlap is produced.

FIG. 13 shows a cable holder, the top side of the screening part of a specific receiving space extending to the same height as that at which the bottom side of the support surface of the following receiving space extends. In the present case, the spacing between the perpendicular projection of the top side of a screening part of the one zone of the cable holder in said projection plane and the perpendicular projection of the bottom side of the support part of the following zone of the same cable holder in this projection plane is equal to 0 mm. Here, the perpendicular projections in question coincide with each other.

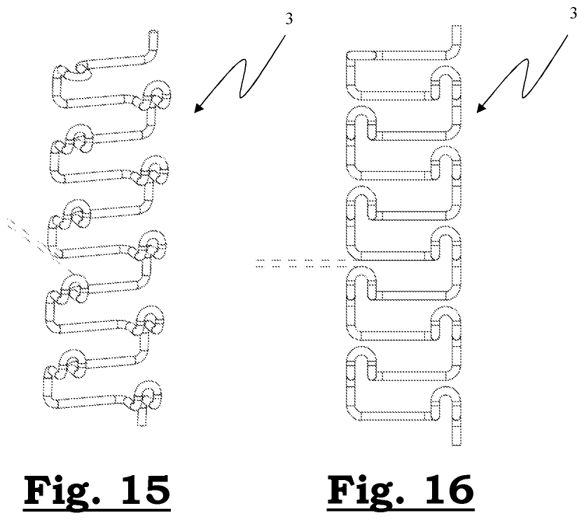

FIG. 15 shows a cable holder of a cable holder system according to at least one embodiment of the invention, wherein the perpendicular projection of the top side of a screening part of the one zone of the cable holder in said projection plane is located below the perpendicular projection of the bottom side of the support part of the following zone of the same cable holder in this projection plane.

The cable holder system is configured such that the zones of cable holders which are placed next to each other and extend at the same height are used for the same cable. In this way, as illustrated in FIG. 1, a cable (2) is supported over its course, at regular instances, in each case at the location of a specific zone of a cable holder. In the case of the cable holder system according to at least one embodiment of the invention, the cables and/or lines are placed in the different receiving spaces of the cable holders, which are positioned next to each other, such that they extend in a direction different from the aforementioned main direction. In practice, as illustrated in FIG. 1, the different cables and/or lines will extend in a direction transverse to the main direction.

When the cable is then pulled straight in the cable holder system, the cable is, as it were, locked, partly due to its rigidity, in the different zones of the different cable holders. In the absence of external forces, it will thus always remain in the different cable holders (3) of the cable holder system (1).

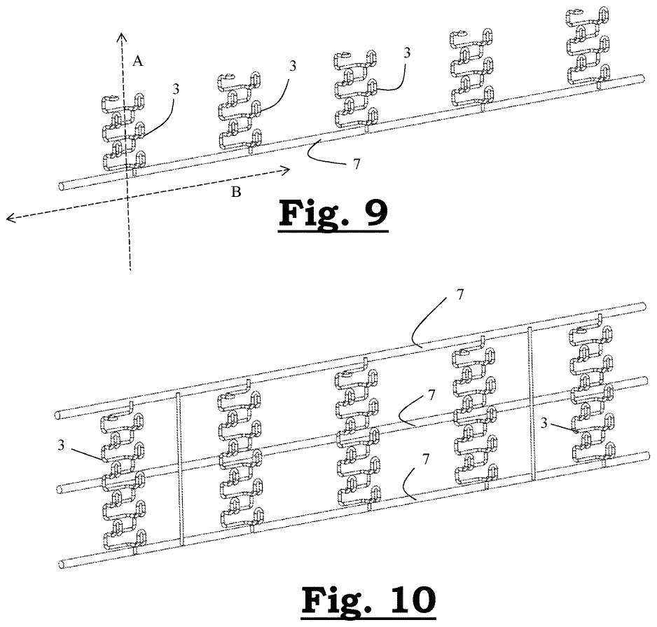

The cable holder system depicted in the figures comprises one or more supporting profiles (7) which extend in parallel and against which the cable holders (3) of a set are able to be secured. In practice, two supporting profiles are usually provided, however it is possible, as illustrated in FIGS. 9 and 10, for only one or three supporting profiles (7) to be provided per cable holder system (1). The supporting profiles are preferably in the form of a pipe, rod or folded profile composed of sheet material. The supporting profiles (7) extend in a direction transverse to said main direction (A).

1. A cable holder system for hygienically securing cables and/or lines, comprising:
a set of at least two cable holders positioned at a distance from each other, wherein each cable holder extends in a main direction and is formed from a one-piece rigid wire profile, wherein the one-piece rigid wire profile comprises a number of successive recurring zones in which the one-piece rigid wire profile is folded a number of times such that a receiving space for a cable and/or line is formed at a location of each zone in the number of successive recurring zones, wherein, in each zone, a support part for the cable and/or line and a screening part are formed by the folding of the one-piece rigid wire profile,
wherein the cable holder system is configured such that, during use:
the cable and/or line extends transverse to the main direction and can be placed bearing against the support part of a specific zone in the number of successive recurring zones by a flexible bending of the cable and/or line along the screening part and the screening part prevents unintentional loss of the cable and/or line from the receiving space,
the screening parts of the number of successive recurring zones of the same cable holder are positioned such that the screening parts are offset with respect to each other in an offsetting direction transverse to the main direction,
spacing between the perpendicular projection of the top side of a screening part of one zone of the cable holder in a projection plane parallel to the main direction and is parallel to the offsetting direction, and
spacing between a perpendicular projection of a bottom side of a support part of a zone following the one zone in the projection plane is at most equal to a diameter of a cable and/or line fitted in the receiving space.

2. The cable holder system according to claim 1, wherein a distance between the receiving spaces of successive zones in the number of successive recurring zones is equal to a thickness of the wire profile.

3. The cable holder system according to claim 1, wherein, between the screening part of the one zone of the cable holder and the screening part of the following zone of the cable holder, an access opening is formed via which the cable or line can be placed in the receiving space.

4. The cable holder system according to claim 1, wherein the screening parts are upright structures in order to prevent the unintentional loss of the cable and/or line from the receiving space of the cable holder.

5. The cable holder system according to claim 1, wherein, as seen from the main direction, the screening parts of successive zones in the number of successive zones of the cable holder are arranged in a staggered fashion.

6. The cable holder system according to claim 1 wherein, for each cable holder, a top end of the screening part in the specific zone extends beyond a bottom side of a next screening part of a zone following the specific zone.

7. The cable holder system according to claim 1 wherein the wire profile has a diameter of between 2 and 10 mm.

8. The cable holder system according to claim 1, wherein the cable holder is made of steel, stainless steel, galvanized steel, or plastic.

9. The cable holder system according to claim 1, further comprising one or more supporting profiles that extend parallel to each other, and against which each cable holder in the set of cable holders are configured to be secured.
